(19) United States
(12) Patent Application Publication
(10) Pub. No.: US 2015/0108380 A1
(43) Pub. Date: Apr. 23, 2015

(54) DEVICE FOR CONTROLLING GAS FLOW VIA WIRELESS SIGNALS

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); YEN-JEN YEH, Yunlin (TW)

(73) Assignee: GRAND MATE CO., LTD., Taichung (TW)

(21) Appl. No.: 14/260,015

(22) Filed: Apr. 23, 2014

(30) Foreign Application Priority Data
Oct. 18, 2013 (TW) 102137724

(51) Int. Cl. G05D 7/06; F16K 37/00; F16K 31/06

(52) U.S. Cl. CPC G05D 7/0635; F16K 31/06; F16K 37/0025
USPC 251/129.04

(57) ABSTRACT

A device for controlling a gas flow by wireless signals includes a control signal provider, a solenoid valve and a controller. The control signal provider is operated by user to generate a control signal, which contains a command. The solenoid valve has a valve body and a solenoid unit, wherein the valve body has a channel therein for a gas flow flowing through, and the solenoid unit opens or closes the channel by control. The controller receives the control signal from the control signal provider, and controls the solenoid unit according to the command in the control signal to open or close the channel of the valve body. It allows user to control a solenoid valve, and obtain the status of the solenoid valve at any place. He/she does not have to operate the gas switch in person.

The current application claims a foreign priority to the patent application of Taiwan No. 102137724 filed on Oct. 18, 2013.

### BACKGROUND OF THE INVENTION

1. Technical Field

The present invention relates generally to a gas switch of a gas appliance, and more particularly to a device which controls a gas flow via wireless signals.

2. Description of Related Art

A gas appliance, such as gas stove, gas water heater, and gas fireplace, is provided with a gas switch on a gas pipe to turn on or turn off a gas flow in the gas pipe. It is advised to turn off the gas switch while he/she is sleeping or out to avoid gas leakage.

FIG. 1 shows a conventional gas switch 100, which is a ball valve for manual control. The gas switch 100 has a handle 102 to be turned for turning on/off a gas flow to a gas appliance 200. For some reasons, the gas switch 100 is mounted at a place, such as under the gas appliance or at a corner, where the user is not easy to reach. Therefore, the user has to search the gas switch 100 by hands, not by eyes, while he/she wants to operate the gas switch 100. Besides, the user always wonders that did I turn off the switch? Then, he/she searched the switch again, and found the switch is off. Therefore, the conventional gas switch 100 is needed to be improved.

### BRIEF SUMMARY OF THE INVENTION

In view of the above, the primary objective of the present invention is to provide a gas switch, which may be controlled via wireless signals.

The present invention provides a device for controlling a gas flow by wireless signals, which includes a solenoid valve and a controller. The solenoid valve has a valve body and a solenoid unit, wherein the valve body has a channel therein for a gas flow flowing through, and the solenoid unit opens or closes the channel by control. The controller is electrically connected to the solenoid unit of the solenoid valve, wherein the controller receives a control signal, which contains a command, and controls the solenoid unit according to the command in the control signal to open or close the channel of the valve body.

With such design, the device of the present invention allows user to control a solenoid valve, and obtain the status of the solenoid valve at any place. He/she does not have to operate the gas switch in person.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch view of the conventional gas switch and the gas appliance;

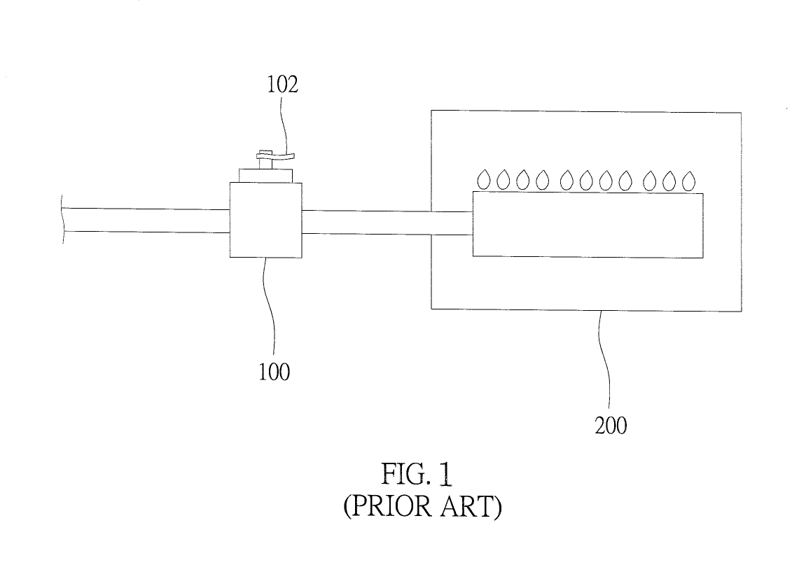

FIG. 2 is a block diagram of a first preferred embodiment of the present invention;

FIG. 3 is a perspective view of the solenoid valve and the controller of the first preferred embodiment of the present invention; and

FIG. 4 is a block diagram of a second preferred embodiment of the present invention.

### DETAILED DESCRIPTION OF THE INVENTION

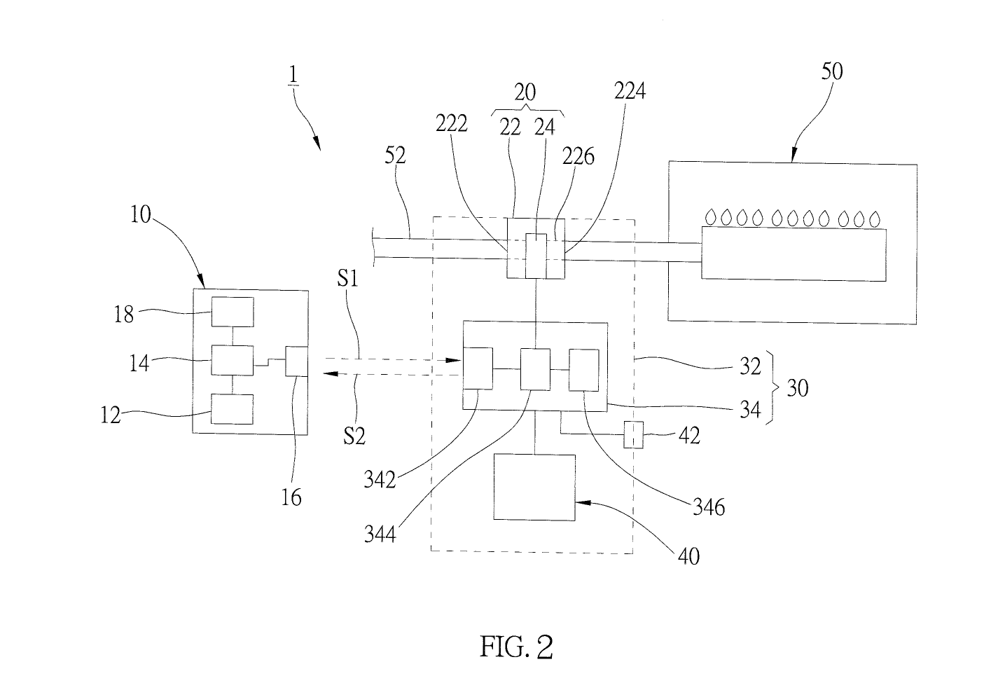

FIG. 2 shows a device 1 of the first preferred embodiment of the present invention for turning on and off a gas flow to a gas appliance, including a control signal provider, which is a remote control 10 in the present embodiment, a solenoid valve 20, a controller 30, and a power supply, which is a battery 40 in the present embodiment.

The remote control 10 has an input interface 12, a control unit 14, a transceiving unit 16, and a display unit 18. In an embodiment, the input interface 12 provides a user to operate in order to turn on or turn off the gas flow. The control unit 14 generates a command according to the selection of the input interface 12. The command includes a turning-on command and a turning-off command. The control unit 14 converts the command into a control signal S1, and then transmits the control signal S1 out through the transceiving unit 16. In an embodiment, the control signal S1 is a radio frequency (RF) signal. In another embodiment, the control signal S1 may be infrared rays, Zigbee, Bluetooth, and so on.

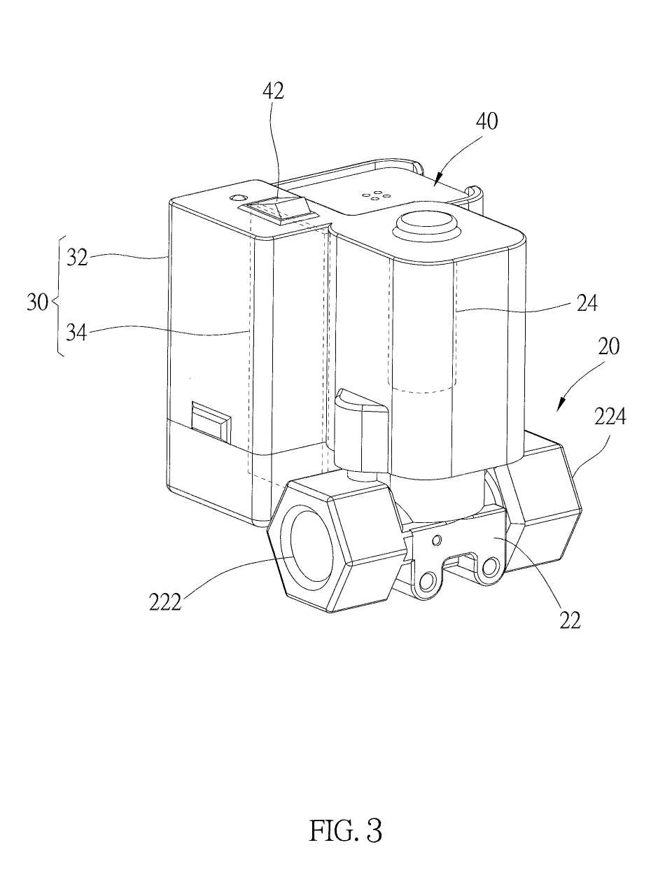

As shown in FIG. 2 and FIG. 3, the solenoid valve 20 is a normally closed solenoid valve, including a valve body 22 and a solenoid unit 24. The valve body 22 is mounted on a gas pipe 52, having an input side 222, an output side 224, and a channel 226 between the input side 222 and the output side 224. The input side 222 and the output side 224 are connected to the gas pipe 52 respectively, and a gas flow in the gas pipe 52 enters the valve body 22 via the input side 222, flows through the channel 226, and leaves the valve body 22 via the output side 224. The solenoid unit 24 is provided on the valve body 22 to open or close the channel 226 by an electrical signal. The solenoid unit 24 normally closes channel 226 of the valve body 22. The solenoid valve 20 is that same as a conventional solenoid valve, so we do not describe the detail here.

The controller 30 has a case 32 and a control circuit 34. The case 32 is mounted on the valve body 22 of the solenoid valve 20, and the control circuit 34 and the battery 40 are received in the case 32. The control circuit 34 includes a transceiving unit 342, an electric control unit 344, and a sensing unit 346. The battery 40 supplies these elements 342, 344, 346 with electric power. The electric control unit 344 is electrically connected to the solenoid unit 24 of the solenoid valve 20, the transceiving unit 342, and the sensing unit 346 respectively. The transceiving unit 342 receives the control signal S1 from the remote control 10, and then the electric control unit 344 interprets the control signal S1 to obtain the command, and controls the solenoid valve 20 accordingly.

The electric control unit 344 also compiles a status of the solenoid valve 20 into a data signal S2, which is a RF (radio frequency) signal, and transmits the data signal S2 to the remote control 10 through the transceiving unit 342. The transceiving unit 16 of the remote control 10 receives the data signal S2, and then the control unit 14 interprets the data signal S2 to obtain the status of the solenoid valve 20 and shows it on the display unit 18, therefore the user may read the status of the solenoid valve 20 on the display unit 18.

The sensing unit 346 senses a voltage of the battery 40, and transmits it to the electric control unit 344. While the sensed voltage of the battery 40 is lower than a predetermined voltage, the electric control unit 344 generates a data signal S2, which indicates that the battery is low, and transmits it to the remote control 10 through the transceiving unit 342. The same as above, the transceiving unit 16 of the remote control 10 receives the data signal S2, and then the control unit 14 interprets it S2, and shows a low-battery warning on the display unit 18. It informs user to change the battery. The data signal S2 may contain the sensed voltage of the battery 40. While sensing unit 346 senses a voltage of the battery 40 lower than a reference voltage, the electric control unit 344 turns off the solenoid valve 20 directly. The reference voltage is lower than the predetermined voltage, and it is the minimum voltage with which the electric control unit 344 can control the solenoid valve 20. In other words, the solenoid valve 20 will be turned off automatically before the battery 40 is dead.

The control circuit 34 further is connected to a switch 42 to be switched between a first condition and a second condition. In an embodiment, the first condition of the switch 42 is ON, and the second condition is OFF. While the control circuit 34 does not receive any control signal, and the switch 42 is switched to the first condition (ON), the control circuit 34 opens the channel 226 in the valve body 22, and the control circuit 34 closes the channel 226 in the valve body 22 while the control circuit 34 does not receive any control signal, and the switch 42 is switched to the second condition (OFF). Therefore, the user still may turn on or off the solenoid valve 20 without the remote control 10.

The power supply may be an AC power supply except for the battery 34. A transformer and a rectifier are required if the device of the present invention is connected to the AC power supply. In practices, the power supply may include an AC power supply for a primary power and a battery for a secondary power. Normally, the AC power supply provides the control circuit 34 with essential power and charges the battery, and the battery provides the control circuit 34 with power only when the AC power supply is disconnected.

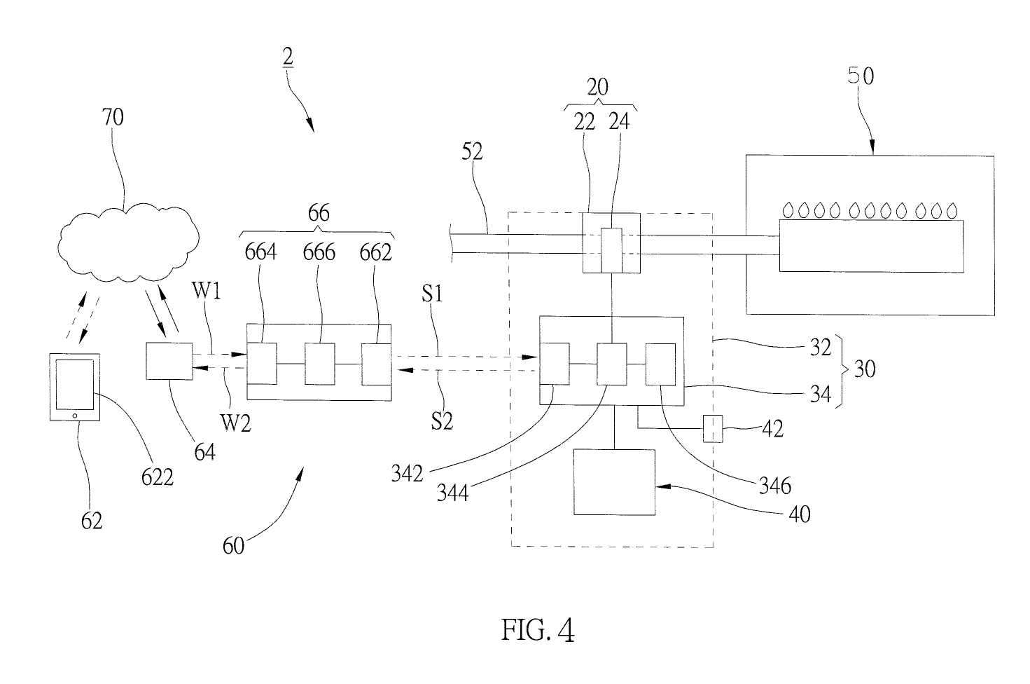

FIG. 4 shows a device 2 for turning on or turning off a gas flow to a gas appliance of the second preferred embodiment of the present invention, which is similar to the device 1 of the first preferred embodiment, except that a control signal provider 60 includes a tablet 62 (remote control), a wireless access point (wireless AP) 64, and an interpreter 66. The tablet 62 has a touch screen 622 to be the display unit, and is installed with an application. User may input the command on the touch screen 622 to turn on or off a gas flow through Internet 70, the wireless AP 64, and the interpreter 66. In practices, it may be through a local network rather than Internet.

The interpreter 66 has a transceiving unit 662, a Wi-Fi transceiving unit 664, and a converting unit 666. User inputs a command through the touch screen 622 of the tablet 62, and the command is converted into a control signal, and then the control signal is transmitted to the wireless AP 66 though Internet 70. The control signal is interpreted into a Wi-Fi control signal W1, which contains the command, at the wireless AP 66, and then the Wi-Fi control signal W1 is transmitted to the interpreter 66. The Wi-Fi transceiving unit 664 of the interpreter 66 receives the Wi-Fi control signal W1, and the converting unit 666 converts it into the control signal S1, and then the control signal S1 is transmitted to the control circuit 34 through the transceiving unit 662 to control the solenoid valve 20 accordingly.

The control circuit 34 transmits the data signal S2, which contains a status of the solenoid valve 20, to the interpreter 66 periodically. The data signal S2 is received by the transceiving unit 662 of the interpreter 66, and is converted into a Wi-Fi data signal W2 by the converting unit 666, and then the Wi-Fi data signal W2 is transmitted to the wireless AP 64 through the Wi-Fi transceiving unit 664. The Wi-Fi data signal W2 is converted into the data signal, which contains the status of the solenoid valve 20, and is transmitted to the tablet 62 through Internet 70, so that user may read the current status of the solenoid valve 20 on the touch screen 622.

As a result, user may control the solenoid valve 20 with the tablet 62 at any place as long as the tablet can connect to Internet, and obtain the current status of the solenoid valve 20 as well.

In conclusion, the device of the present invention allow user to remotely control a solenoid valve, and obtain the status of the solenoid valve. In comparison with the prior art, the present invention overcomes the drawback of the prior art, user has to operate the switch in person, and the switch is hard to reach. In addition, the control circuit, the battery, and the switch are directly mounted on the solenoid valve, which simplifies the design of the elements of the present invention, and makes it easier to install the device.

It must be pointed out that the embodiments described above are only some preferred embodiments of the present invention. All equivalent structures which employ the concepts disclosed in this specification and the appended claims should fall within the scope of the present invention.

What is claimed is:

1. A device for controlling a gas flow by wireless signals, comprising:
a solenoid valve having a valve body and a solenoid unit, wherein the valve body has a channel therein for a gas flow flowing through, and the solenoid unit opens or closes the channel by control; and
a controller electrically connected to the solenoid unit of the solenoid valve, wherein the controller receives a control signal, which contains a command, and controls the solenoid unit according to the command in the control signal to open or close the channel of the valve body.

2. The device of claim 1, wherein the controller has a case and a control circuit; the case is mounted on the valve body; the control circuit is received in the case, and is electrically connected to the solenoid unit; and the control circuit receives the control signal to control the solenoid unit accordingly.

3. The device of claim 2, further comprising a power supply to supply the control circuit with electric power, wherein the power supply has a battery received in the case, or has a rectifier and a transformer.

4. The device of claim 2, further comprising a switch, which is electrically connected to the control circuit, to be switch between a first condition and a second condition, wherein the solenoid unit opens the channel of the valve body when the switch is switched to the first condition, and closes the channel when the switch is switched to the second condition.

5. The device of claim 1, wherein the solenoid valve is a normally closed solenoid valve.

6. The device of claim 1, wherein the control signal is a radio frequency signal.

7. The device of claim 1, wherein the controller has a transceiving unit and an electric control unit; the transceiving unit receives the control signal; the electric control unit is electrically connected to the solenoid unit of the solenoid valve; the electric control unit receives the control signal from the transceiving unit to control the solenoid unit accordingly; and the electric control unit compiles a status of the solenoid valve into a data signal, and transmits the data signal out through the transceiving unit.

8. The device of claim 7, further comprising a battery to supply the controller with electric power, wherein the controller further includes a sensing unit for sensing a voltage of the battery; and the electric control unit generates a data signal, which indicates the battery is low, while the voltage sensed by the sensing unit is lower than a predetermined voltage, and then transmits the data signal out through the transceiving unit.

9. The device of claim 7, further comprising a battery to supply the controller with electric power, wherein the controller further includes a sensing unit for sensing a voltage of the battery; and the electric control unit controls the solenoid unit to close the channel of the valve body while the voltage sensed by the sensing unit is lower than a reference voltage.

10. The device of claim 1, further comprising a control signal provider for generating and transmitting the control signal.

11. The device of claim 10, wherein the controller has a transceiving unit and an electric control unit; the transceiving unit receives the control signal from the control signal provider; the electric control unit is electrically connected to the solenoid unit of the solenoid valve; the electric control unit controls the solenoid unit according to the control signal from the transceiving unit; the electric control unit compiles a status of the solenoid valve into a data signal, and transmits the data signal to the control signal provider through the transceiving unit; and the control signal provider has a display unit to show the status of the solenoid valve.

12. The device of claim 11, wherein the control signal provider has a remote control, a wireless access point, and an interpreter; the interpreter has a transceiving unit, a Wi-Fi transceiving unit, and a converting unit; the display unit is provided on the remote control; the remote control generates the control signal, and transmits the control signal to the wireless access point; the wireless access point converts the control signal into a Wi-Fi control signal, and transmits the control signal to the interpreter; the Wi-Fi transceiving unit of the interpreter receives the Wi-Fi control signal; the converting unit converts the Wi-Fi control signal into the control signal, and transmits the control signal out through the transceiving unit; the transceiving unit further receives a data signal, which contains a status of the solenoid valve, and then the converting unit converts the data signal into a Wi-Fi data signal, and transmits the Wi-Fi data signal to the wireless access point through the Wi-Fi transceiving unit; and the interpreter converts the Wi-Fi data signal into the data signal, and transmits the data signal to the remote control to show the status of the solenoid valve on the display unit.

13. The device of claim 11, further comprising a battery to supply the controller with electric power, wherein the controller further includes a sensing unit for sensing a voltage of the battery; and the electric control unit generates a data signal, which indicates the battery is low, while the voltage sensed by the sensing unit is lower than a predetermined voltage, and transmits the data signal to the control signal provider through the transceiving unit to show a low-battery warning on the display unit.
